(19) United States
(12) Patent Application Publication
(10) Pub. No.: US 2016/0350955 A1
(43) Pub. Date: Dec. 1, 2016

(54) IMAGE PROCESSING METHOD AND DEVICE

(71) Applicant: SuperD Co. Ltd., Shenzhen (CN)

(72) Inventors: YANQING LUO, Shenzhen (CN); PEIYUN JIAN, Shenzhen (CN); NING LIU, Shenzhen (CN)

(73) Assignee: SuperD Co. Ltd.

(21) Appl. No.: 14/971,099

(22) Filed: Dec. 16, 2015

(30) Foreign Application Priority Data
May 27, 2015 (CN) 2015-10278207.X

(51) Int. Cl. G06T 11/60; G06F 3/0482; G06F 17/24; G06T 19/20; G06T 1/60; G06F 3/0484; G06T 15/00

(52) U.S. Cl. CPC G06T 11/60; G06F 3/04845; G06F 3/0482; G06T 15/00; G06T 19/20; G06T 1/60; G06F 17/24; G06F 3/04842; G06T 2207/10004; G06T 2200/24

(57) ABSTRACT

The present disclosure provides an image processing method. The method includes the following steps. Two to-be-processed view images, namely a first view image and a second view image are acquired. Both are 2D images. A user instruction is received to determine special-effect data to be inserted to the to-be-processed view images. Based on special effect attribute information, the special-effect data are combined with the first and second view images to obtain a 3D special effect view image. After the special-effect data are combined with the first and second view images, the same special effect has a horizontal parallax between the two combined view images. The special effect attribute information includes the position information of the special-effect data in the to-be-processed view images and the number of view images required to generate. The 3D special effect view images are stored in one or more files.

### CROSS-REFERENCES TO RELATED APPLICATIONS

This application claims the priority of Chinese Patent Application No. CN201510278207.X, filed on May 27, 2015, the entire contents of which are incorporated herein by reference.

### FIELD OF THE DISCLOSURE

The present disclosure generally relates to the field of 3D display technologies and, more particularly, relates to an image processing method and an image processing device.

### BACKGROUND

In three-dimensional (3D) display technologies, human-computer interaction is not limited to two-dimensional (2D) plane and has been extended to three-dimensional (3D) space. In pursuit of realism, interaction in three-dimensional space must be closely integrated with visual effects. As smart phones, tablet computers and other portable electronic devices are getting widely used, users may capture photos and videos using the built-in cameras and then may use application software to process the captured photos and videos, for example, for image enhancement, image modification, etc. However, such processing of the photos and videos may be still limited to 2D plane effects rather than dynamic 3D spatial effects. In pursuit of realistic 3D viewing experience, users are demanding dynamic 3D alteration of images data captured or stored in the portable electronic devices.

The disclosed image processing method and image processing device are directed to solve one or more problems set forth above and other problems in the art.

### BRIEF SUMMARY OF THE DISCLOSURE

Directed to solve one or more problems set forth above and other problems in the art, the present disclosure provides a 3D image display method and a handheld terminal to improve viewing experience.

One aspect of the present disclosure provides an image processing method. The method includes the following steps. Two to-be-processed view images, a first view image and a second view image are acquired. Both the first view image and the second view image are 2D images. A user instruction is received to determine special-effect data to be inserted to the to-be-processed view images. Based on special effect attribute information, the special-effect data are combined with the first view image and the second view image to obtain a 3D special effect view image. Then, the 3D special effect view image is stored. A horizontal parallax exists between the special-effect data combined with the first view image and the special-effect data combined with the second view image. The special effect attribute information includes position information of the special-effect data in the to-be-processed view images and a number of frames of the view images required to be generated.

Another aspect of the present disclosure provides an image processing device. The image processing device includes a view image acquisition unit configured to acquire two to-be-processed view images, a first view image and a second view image, both being 2D images, a special effect selection unit configured to receive a user instruction and to determine special-effect data to be inserted to the to-be-processed view images, a combining unit configured to, based on special effect attribute information, combine the special-effect data with the first view image and the second view image to obtain a 3D special effect view image, and a storage unit configured to store the 3D special effect view image. A horizontal parallax exists between the special-effect data combined with the first view image and the special-effect data combined with the second view image. The special effect attribute information includes position information of the special-effect data in the to-be-processed view images and a number of frames of the view images required to be generated.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic view of dynamic effect of an exemplary image processing method according to the disclosed embodiments;

FIG. 2 illustrates a flow chart of an exemplary image processing method according to the disclosed embodiments;

FIG. 3 illustrates a schematic view of an exemplary to-be-processed view image;

FIG. 4 illustrates a schematic view of replicating the exemplary to-be-processed view image in FIG. 3;

FIGS. 5a-5f illustrate a schematic view of an exemplary process of implementing dynamic effect in each view image frame according to the disclosed embodiments;

FIG. 6 illustrates a schematic view of the effect of inserting a border to the exemplary to-be-processed view image according to the disclosed embodiments;

FIG. 7 illustrates a block diagram of an exemplary image processing device according to the disclosed embodiments; and

FIG. 8 illustrates a block diagram of another exemplary image processing device according to the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. It should be understood that the exemplary embodiments described herein are only intended to illustrate and explain the present invention and not to limit the present invention.

When no conflict exists, the exemplary features illustrated in various embodiments may be combined and/or rearranged. The specific details provided in the descriptions of various embodiments are intended to help understanding the present disclosure. However the present disclosure may be implemented in other manners that are not described herein. Thus, the scope of the present disclosure is not limited to the disclosed embodiments. In various embodiments, the terms “first” and “second”, etc., are used to describe technical differentiations, and such terms may be replaced without departing from the scope of the present disclosure.

The present disclosure provides an image processing method for 3D image capturing or other image processing applications by, for example, built-in camera equipped mobile terminals, tablet computers, etc. The image processing method according to the present disclosure may also apply to, but is not limited to, 3D mobile phones, tablet computers, and other portable electronic devices that are integrated with light separation devices such as gratings. The image processing method according to the present disclosure may also apply to 2D mobile phones.

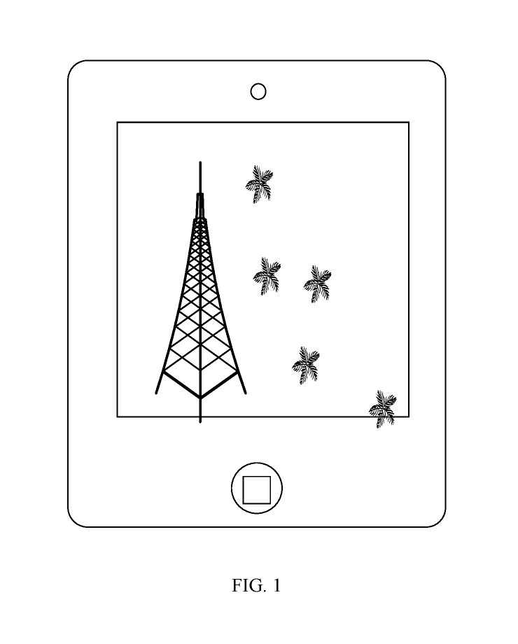

FIG. 1 illustrates a schematic view of dynamic effect of an exemplary image processing method according to the disclosure. Referring to FIG. 1, after a user captures a 2D image by using a smart phone, the user may want to enhance the captured image with dynamic 3D effects, such as floating feathers, snowflakes, bubbles, and rain drops, etc. The image processing method according to the present disclosure may be used by the user to achieve the desirable effects. As shown in FIG. 1, 3D effects of floating puffy flowers are added to the image captured by the user on a smart phone.

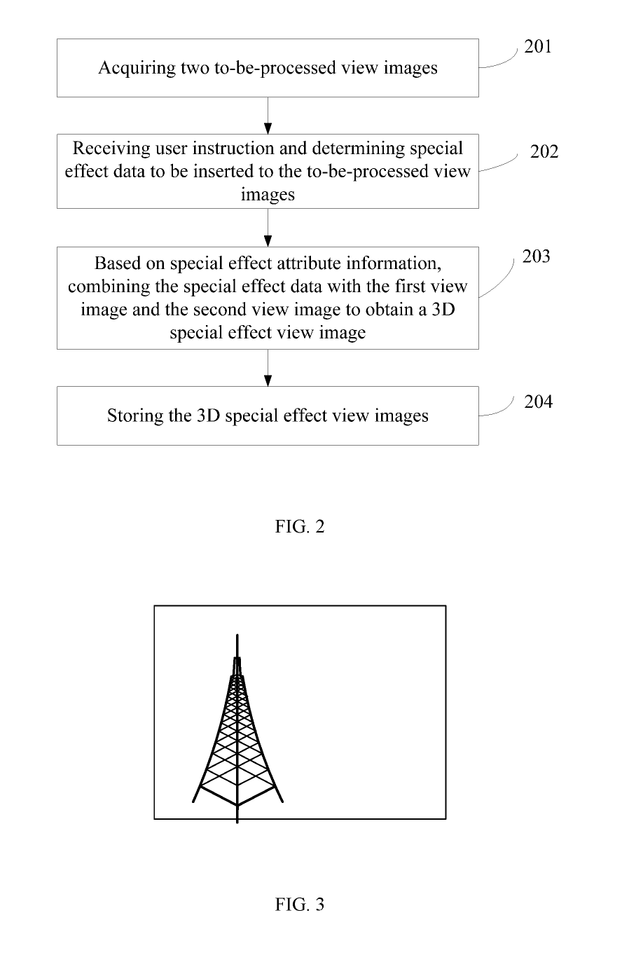

FIG. 2 illustrates a flow chart of an exemplary image processing method according to the disclosure. Referring to FIG. 2, the image processing method may include the following steps.

Step S201: acquiring two to-be-processed images. The two to-be-processed images may be a first view image and a second view image. The first view image and the second view image are 2D images. To achieve 3D viewing effect, two view images may be required. The two view images have same special effect and have a horizontal parallax between each other. In the meantime, two to-be-processed view images may be needed as background images, the first view image and the second view image.

In one embodiment, the two view images may be identical in, for example, dimension, content, color, etc. The second view image may be replicated from the first view image after the first view image is acquired. Alternatively, the two view images may be acquired by shooting the same scene twice.

In another embodiment, the first view image and the second view image may be different. For example, the first view image may include scenes such as landscape, people, etc., as background while the second view image may be simply blank or may include transparent grid image. After special effects are applied, the second view image may be coupled with the first view image while maintaining the original scenes of the first view image.

Further, the to-be-processed images may be acquired by the user using the camera, retrieved from portable electronic device memory, downloaded from the internet, or obtained by other means. In one embodiment, the to-be-processed images are acquired by the user using the camera.

Step S202: receiving a user instruction and determining special-effect data to be inserted to the to-be-processed view images.

In this step, the user may select the desired special-effect data and may instruct certain image processing operations. Special-effect data, as used herein, may refer to data used for creating certain display or viewing effect in one or more images. An electronic device (for example, a smart phone) may obtain the special-effect data required for the view image processing based on the received user instruction. In one embodiment, an application program may be used to implement the image processing method.

The user may select the requested special-effect data from a dropdown list provided by the application program, from a search engine interface provided by the application program, or from a preconfigured template or model. For example, the user may enter text command in the search engine interface. According to the text command, the search engine may search the special-effect database to obtain the special-effect data searched by the user, which is then presented to the user to be selected by the user.

Step S203: based on the special effect attribute information, combining the special-effect data with the first view image and/or the second view image to obtain the 3D special effect view images.

Specifically, in this step, the portable electronic device may combine the special-effect data with the to-be-processed images to obtain the 3D special effect view images based on the special effect attribute information.

More specifically, after combining the special-effect data with the first view image and the second view image, the corresponding effect may have a horizontal parallax. The special effect attribute information may include position information of the special-effect data located in the to-be-processed view images and a number of view image frames required to be generated. When the number of the view image frames reaches a certain value, the desired dynamic effect may be observed in the video playback.

That is, when the portable electronic device determines the number of the view image frames reaches a threshold value, the portable electronic device may automatically playback the number of the view image frames as video such that the user can observe the 3D effect. Alternatively, the portable electronic device may prompt the user to confirm the playback before playing the number of the view image frames.

Multiple implementation methods may be used to combine the special effect with the to-be-processed view images. In one embodiment, for example, when butterflies are used as the special effect, image pixels in a certain portion of the view images may be replaced by pixel data corresponding to the butterflies to obtain the desired combination view images.

Generally, one 3D-effect view image may include two view images. The two view images may be the first view image after being inserted with the special-effect data and the second view image after being inserted with the special-effect data. The same special-effect data in the two view images may have parallax after the special-effect data are combined with the first view image and the second view image respectively. The parallax may be determined by the position information and/or the first view image and the second view image.

For example, the position coordinate of the special-effect data in the first view image may be (100, 100). Both the row and column coordinates of the first view image are 100. The corresponding position coordinate in the second view image may be (102, 100). The special-effect insertion position in each view image in different frames may be selected randomly, may be determined based on the user input, or may be determined by certain rules, such as a trajectory algorithm.

Step S204: storing the 3D special effect view images. Specifically, after the 3D special-effect data is inserted to the 2D images in steps S201-S203, the 3D view images or the 3D view image frames with the special effect may be stored in, for example, an MP4 format or other displayable format. Then, the stored 3D view images or the 3D view image frames may be displayed or played back by the 3D device and the 3D dynamic effect may be observed on the 2D background images.

FIG. 3 illustrates a schematic view of an exemplary to-be-processed view image. Referring to FIG. 3, the electronic device may acquire a 2D to-be-processed view image. The user may want to use the electronic device to enhance the 2D view image to insert 3D dynamic effect of floating snowflakes. The view image may be downloaded or captured by the user.

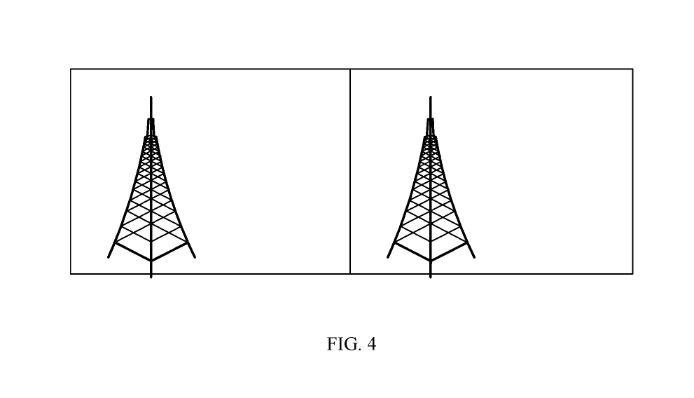

According to the user's instruction, the electronic device may determine the view image that requires image enhancement. The view image shown in FIG. 3 may be replicated to obtain two identical 2D view images side by side, as shown in FIG. 4. Then, the electronic device may determine the desired dynamic special effect to be inserted into the view image based on the user instruction. For example, the user may select snowflakes as the dynamic effect from a dropdown list.

In one embodiment, the position information of the special effect attribute information may be generated randomly or selected by the user through clicking the display screen. The number of view image frames may be determined by a model algorithm or may be input by the user. The special effect attribute information may also include variation information to control size variation, trajectory variation, and/or color variation.

Subsequently, the electronic device may combine the special effect in certain size and color with the each view image in the position corresponding to each view image's position information of the special effect attribute information. The view image combination may include pixel data replacement. For example, the pixel data at the corresponding position of each view image may be replaced by the special effect pixel data.

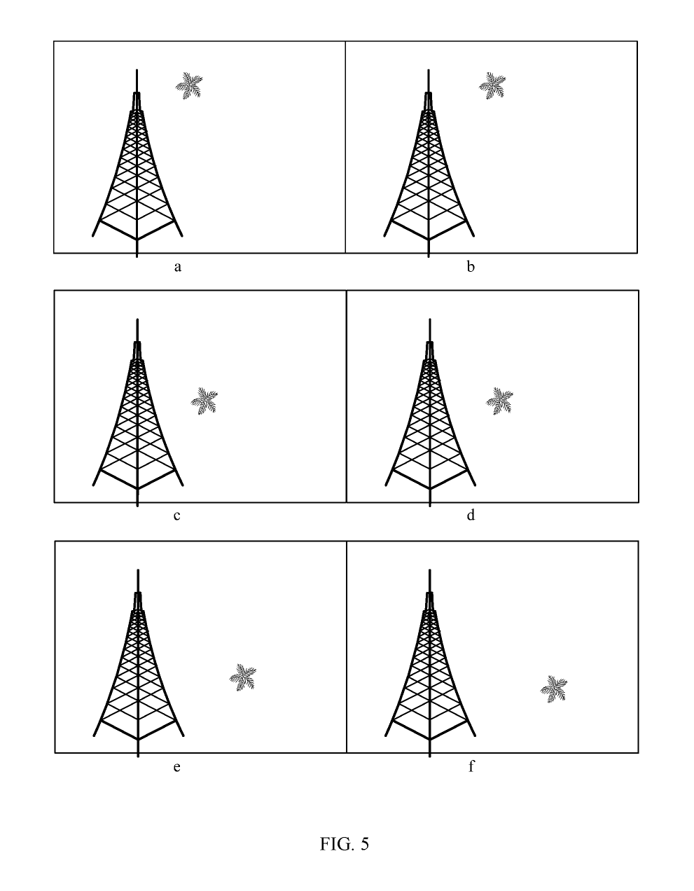

FIGS. 5a-5f illustrate a schematic view of an exemplary process of implementing dynamic effect in each view image frame according to the present disclosure. FIG. 5a and FIG. 5b are the left view image and the right view image in a first view image frame (3D) or frames (2D). Similarly, FIG. 5c and FIG. 5d are the left view image and the right view image in a second view image frame (3D) or frames (2D), and FIG. 5e and FIG. 5f are the left view image and the right view image in a third view image frame (3D) or frames (2D).

Referring to FIGS. 5a-5f, each special effect snowflake may be at different position in each view image frame. However, each special effect snowflake may have a position displacement between the two view images of each frame in addition to the position change in different frames. When multiple view image frames are played continuously, a dynamic effect may be observed. When multiple view image frames, each containing two view images inserted with the special effect, are played continuously, 3D effect may be observed due to the horizontal parallax of the special effect. Even if the background view images are 2D, 3D effect may be observed as shown in FIG. 1. Alternatively, in a 2D display, each frame may contain one of the two images inserted with the special effect and may be played back alternatingly to effect a 3D display with the special effect.

In one embodiment, in order to achieve the snowflake's 3D effect on a 3D display screen, the snowflake position may have a horizontal displacement between the left view image and the right view image. The displacement value may be randomly selected within a certain range. Moreover, the dynamic 3D effect may be implemented by using a template. The template may be used to generate the snowflakes. The template may include the snowflake position, the snowflake size, the snowflake parallax between two view images of each frame, and the snowflake trajectory, etc.

To interactively generate snowflakes, the user may first click a position of insertion, and the electronic device may insert snowflakes at the position clicked by the user and then spread out circularly or radially.

To randomly generate snowflakes, the user does not need to indicate any position of insertion, and the electronic device may randomly determine an initial insertion position and may insert snowflakes at the determined position and then spread out circularly or radially.

The interactive generation method and the random generation method may be similar except that the interactive method may generate the first special effect at the position clicked by the user. The special effect motion model may be a circular motion model. The user clicked position may be the center of a circle. The special effect at the radius r may be moved to the position at the radius r′. r′=kr. k is a scalar value and may not alter the direction of r.

In the previous embodiments, 3D effect may be observed on the 3D viewing device. However, 3D effect may not be observed on the 2D viewing device. On the 2D viewing device, only a plurality of continuously animated snowflake view images may be observed, like animated GIF images. In order to observe 3D effect on the 2D device, after the step S203, the user may use the electronic device to combine the special-effect data with the first view image and the second view image to obtain the view images with 3D special effect based on the special effect attribute information. Further, the electronic device may insert a border to the to-be-processed first view image or the to-be-processed second view image. More specifically, the border may be inserted to one of the two view images of each frame before the special effect is inserted.

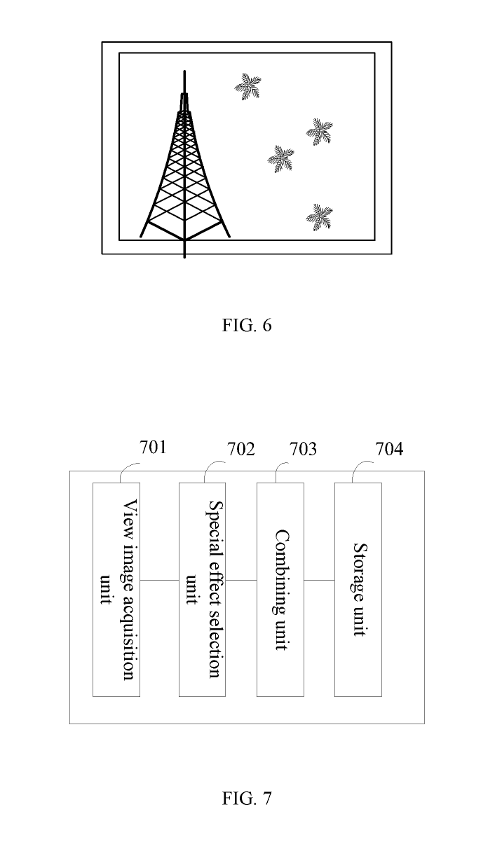

FIG. 6 illustrates a schematic view of the effect of inserting a border to the exemplary to-be-processed view image according to the present disclosure. Referring to FIG. 6, when a plurality of 2D view images with the border is played continuously, the user may experience a 3D like dynamic effect. That is, when the frame of the left view image inserted with the special effect data and the frame of the right view image inserted with the special effect data are played back alternatingly and continuously, 3D effect may also be achieved. Thus, the 2D and 3D compatible effect may be achieved.

In certain embodiment, the border may be inserted. When the first view image and the second view image (for example, a blank image) are different, the view image with content may be inserted with the border.

After the 3D dynamic special effect has been inserted to the to-be-processed view images, the electronic device may store the view images with the 3D special effect. Specifically, storing the view images may include the following.

In one embodiment, the first view images of each combined frame may be stored sequentially. Then, the second view images of each combined frame may be stored sequentially. Both the sequence of first view image frames and the sequence of the second view image frames may be stored in two separated files. When the stored files are played back, the view images may be combined and played sequentially.

In another embodiment, the first view image and the second view image in each frame may be combined or paired together to form a view image sequence corresponding to the frame number of the special effect attribute information. The view image sequence may be stored sequentially in a file. When the stored file is played back, the view images may be played sequentially.

In another embodiment, the storage method may be optimized for file transfer. The to-be-processed view images and the dynamic special effect attribute information and data may be stored in separate files. The receiving electronic device may process the to-be-processed view images based on the received dynamic special effect attribute information and data to obtain the 3D view images with the dynamic special effect identical to that of the sending electronic device. Because the to-be-processed view images and the dynamic special effect attribute information and data are transmitted in separate files, the transmission data volume may be reduced substantially.

In certain embodiments, the border may be inserted. Storing the view images with the border special effect may include the following methods.

One method may store the first view images corresponding to each combined frame sequentially, store the second view images corresponding to each combined frame sequentially, and store the border corresponding to each view image frame sequentially. The data may be stored in separate files. When the user plays the stored content on the 3D device, the user may simply open the stored file and play sequentially. When the user wants to transmit the stored data to a 2D device that does not support 3D display, the user may only need to transmit the border sequence and one of the two combined view image sequence. Not transmitting the entire stored data may reduce the transmission data volume.

Alternatively, another method may combine the first view image and the second view image of each frame to form a view image sequence corresponding to the frame number of the special effect attribute information, may store the view image sequence sequentially, and may store the border sequence corresponding to each view image frame sequentially. When the user wants to play the stored data on a 3D device or to transmit the stored data to a 3D device, the user may only need to play or transmit the view image sequence and may not transmit the border sequence. On the other hand, when the user wants to transmit the stored data to a 2D device, the user may need to transmit the view image sequence and the border sequence, which may be combined with the view images before being played.

Further, the border may be combined with the first view image and the second view image of each frame to form a view image sequence with the border corresponding to the frame numbers of the special effect attribute information. Then the combined view image sequence may be stored. When transmitting the stored data, the user may transmit the entire view image sequence. When received by a 2D device, the view image sequence may be played directly and the 3D like dynamic effect may be observed.

The present disclosure provides the image processing method in various embodiments. The method may acquire two identical to-be-processed view images for each frame. Based on the user instruction, the method may determine the special-effect data and the special effect attribute information that will be inserted to the to-be-processed view images. The special-effect data may be combined with the 2D to-be-processed view images to obtain the 3D special effect view images. When the 3D special effect view images are played, desired 3D viewing experience may be observed to the user's satisfaction.

FIG. 7 illustrates a block diagram of an exemplary image processing device according to the present disclosure. Referring to FIG. 7, the image processing device may include a view image acquisition unit 701, a special effect selection unit 702, a combining unit 703, and a storage unit 704.

The view image acquisition unit 701 may be configured to acquire two to-be-processed view images, namely, the first view image and the second view image. The first view image and the second view image may be 2D images.

The special effect selection unit 702 may be configured to receive user instructions to determine the special-effect data that will be inserted to the to-be-processed view images and the special effect attribute information.

The combining unit 703 may be configured to combine the special-effect data with the first view image and the second view image to obtain a 3D special effect view image, based on the special effect attribute information. After the special-effect data are inserted to the first view image and the second view image, the same special-effect data may have a horizontal parallax between the first view image and the second view image. The special effect attribute information may include the position information of the special-effect data in the to-be-processed view images and the number of the view image frames required to generate.

The storage unit 704 may be configured to store the view images with the 3D special effect and, if necessary, the user selected special-effect data and special effect attribute information.

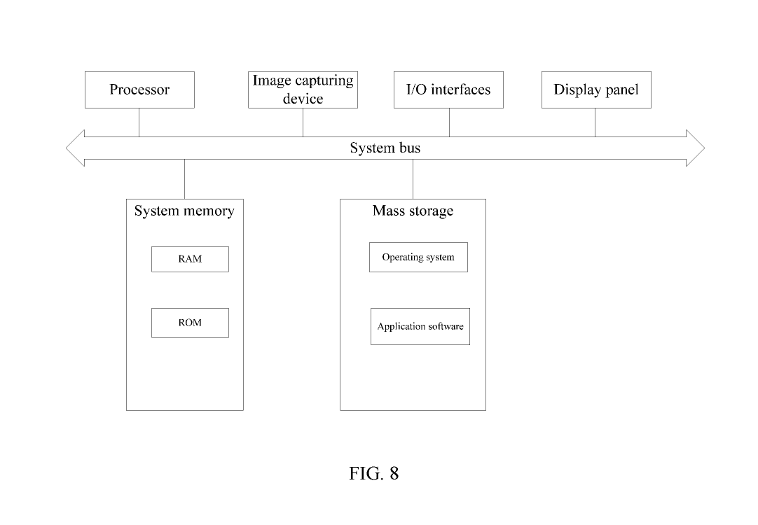

FIG. 8 illustrates a block diagram of another exemplary image processing device according to the present disclosure. Referring to FIG. 8, for example, the image processing device may be a tablet computer, a smart phone, or any other portable electronic device with built-in camera. Such image processing devices may or may not support 3D display.

As shown in FIG. 8, the image processing device may be a computer system that includes a processor, a built-in camera, I/O interfaces, a display panel, system memory, mass storage, and a system bus that connects the built-in camera, the I/O interfaces, the display panel, the system memory, and the mass storage to the processor.

As shown in FIG. 8, the memory storage part of the image processing device may include the system memory and the mass storage. The system memory may further include ROM and RAM. The basic input and output system software may be stored in ROM. The operating system software, application software, data, and various other software programs and modules may be stored in mass storage.

The mass storage may connect to the processor through a mass storage controller (not shown) connected to the system bus. The mass storage and other related computer readable media may provide the non-volatile storage for the computer system.

The computer readable media may include hard drive or CD-ROM drive, etc. However it should be understood by those skilled in the art that the computer readable media may include any computer storage media that can be accessed by the computer system.

The computer readable media may include, but is not limited to, any volatile or non-volatile media with or without moving parts for the purpose of storing computer readable instructions, data structures, program modules, or any other data. For example, the computer readable media may include, but is not limited to, RAM, ROM, EPROM, EEPROM, flash memory or other solid state memory, or any other media that store information and allow the computer system to retrieve the stored information.

The computer system may connect to communication network through the network interface element connected to the system bus. The computer system may also include the I/O interface controller (not shown) to receive and process the input data from various input equipment such as touch pad, and electronic stylus, etc. Similarly, the I/O interface controller may transmit output data to various output equipment such as display panel, and network interface element, etc. The display panel may connect to the system bus through a graphics adapter or a graphics processing unit (not shown).

In one embodiment, the image processing device may include an image acquisition device, such as a camera, configured to capture to-be-processed view images and to allow the processor to apply the image processing method.

As briefly described above, a plurality of program modules and data files, for example, the operating system for controlling the operation of the display panel, may be stored in the system memory such as RAM and the mass storage of the computer system. The mass storage, ROM, and RAM may store one or more program modules. Specifically, the mass storage, ROM, and RAM may store application programs executed by the processor.

The computer system of the image processing device may store a specific group of software program code that may be executed by the processor to perform the operations described in the image processing method according to the present disclosure.

The image processing device may incorporate the image processing method described in the previous embodiments.

The present disclosure provides an image processing device. The device may be configured to acquire two to-be-processed view images. Special-effect data and special effect attribute information may be selected for the to-be-processed view images. The special-effect data may be combined with the 2D to-be-processed view images to obtain the view images with the 3D special effect. The desired 3D viewing experience may be observed to the user's satisfaction.

The units of the image processing device and the steps of the image processing method disclosed in various embodiments may be implemented in electronic hardware, computer software or a combination of electronic hardware and computer software. The device structure and the method steps are described in terms of general functions to clearly illustrate the interchangeability between the electronic hardware and computer software. Whether a certain function is implemented in electronic hardware, computer software or combination of electronic hardware and computer software may be determined according to the specific application of the technical solution and the design constraints. Those skilled in the art may implement the disclosed functions in different ways pertaining to each specific application without departing from the scope of the present disclosure.

The image processing method or algorithm according to the present disclosure may be implemented in hardware, software module executed by processor, or combination of both. The software module may be stored in RAM, system memory, ROM, EPROM, EEPROM, registers, hard drive, portable drive, CD-ROM, or any other suitable storage medium known to those skilled in the art.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. An image processing method, comprising:
acquiring two to-be-processed view images, a first view image and a second view image, both being 2D images;
receiving a user instruction and determining special-effect data to be inserted to the to-be-processed view images;
based on special effect attribute information, combining the special-effect data with the first view image and the second view image to obtain a 3D special effect view image; and
storing the 3D special effect view image,
wherein:
a horizontal parallax exists between the special-effect data combined with the first view image and the special-effect data combined with the second view image; and
the special effect attribute information includes position information of the special-effect data in the to-be-processed view images and a number of frames of the view images required to be generated.

2. The image processing method of claim 1, wherein the first view image and the second view image are identical, and acquiring the two to-be-processed view images further includes:
acquiring the first to-be-processed view image; and
replicating the first to-be-processed view image to obtain the second to-be-processed view image.

3. The image processing method of claim 1, wherein determining the special-effect data further includes:
receiving a user instruction when a user selects from a dropdown list in a corresponding application program; and
determining the special-effect data based on the user instruction and the dropdown list selection.

4. The image processing method of claim 1, wherein determining the special-effect data further includes:
receiving a user instruction when the user enters a text command; and
searching the special-effect data in a special-effect database based on the text command.

5. The image processing method of claim 1, wherein:
the special effect attribute information is determined by interpreting instructions entered by the user or by accessing preconfigured information stored in a template.

6. The image processing method of claim 5, wherein combining the special-effect data with the first view image and the second view image to obtain a 3D special effect view image further includes:
based on position information corresponding to each view image frame, combining the special-effect data with each view image frame at a corresponding position,
wherein combining further includes replacing pixel data at corresponding positions of each view image frame with pixel data from the special-effect data.

7. The image processing method of claim 2, before combining the special-effect data with the first view image and the second view image to obtain a 3D special effect view image, further including:
adding a border to the first view image or the second view image.

8. The image processing method of claim 1, wherein storing the 3D special effect view image further includes:
storing view image frames corresponding to the first view image sequentially in one file; and
storing view image frames corresponding to the second view image sequentially in another file.

9. The image processing method of claim 1, wherein storing the 3D special effect view image further includes:
combining the first view image and the second view image in each of the frames corresponding to the frame number of the special effect attribute information to form a view image sequence; and
storing the view image sequence sequentially in a file.

10. The image processing method of claim 7, wherein storing the 3D special effect view image further includes:
storing view image frames corresponding to the first view image sequentially;
storing view image frames corresponding to the second view image sequentially; and
storing border of each view image frame sequentially.

11. The image processing method of claim 7, wherein storing the 3D special effect view image further includes:
combining the first view image and the second view image in each of the frames corresponding to the frame number of the special effect attribute information to form a view image sequence;
storing the view image sequence sequentially in a file; and
storing border of each view image frame sequentially.

12. The image processing method of claim 7, wherein storing the 3D special effect view image further includes:
combining the first view image, the second view image, and the border of the first view image or the second view image in each of the frames corresponding to the frame number of the special effect attribute information to form a view image sequence with a border; and
storing the view image sequence sequentially in a file.

13. An image processing device, comprising:
a view image acquisition unit configured to acquire two to-be-processed view images, a first view image and a second view image, both being 2D images;
a special effect selection unit configured to receive a user instruction and to determine special-effect data to be inserted to the to-be-processed view images;
a combining unit configured to, based on special effect attribute information, combine the special-effect data with the first view image and the second view image to obtain a 3D special effect view image; and
a storage unit configured to store the 3D special effect view image,
wherein:
a horizontal parallax exists between the special-effect data combined with the first view image and the special-effect data combined with the second view image; and
the special effect attribute information includes position information of the special-effect data in the to-be-processed view images and a number of frames of the view images required to be generated.

14. The image processing device of claim 13, wherein the first view image and the second view image are identical, and the view image acquisition unit is further configured to:
acquire the first to-be-processed view image; and
replicate the first to-be-processed view image to obtain the second to-be-processed view image.

15. The image processing device of claim 13, wherein, to determine the special-effect data, the special effect selection unit is further configured to:
receive a user instruction when a user selects from a dropdown list in a corresponding application program; and
determine the special-effect data based on the user instruction and the dropdown list selection.

16. The image processing device of claim 13, wherein, to determine the special-effect data, the special effect selection unit is further configured to:
receive a user instruction when the user enters a text command; and
search the special-effect data in a special-effect database based on the text command.

17. The image processing device of claim 13, wherein, to determine the special-effect data, the special effect selection unit is further configured to:
determine the special effect attribute information by interpreting instructions entered by the user or by accessing preconfigured information stored in a template.

18. The image processing device of claim 17, wherein the combining unit is further configured to:
based on position information corresponding to each view image frame, combine the special-effect data with each view image frame at a corresponding position by replacing pixel data at corresponding positions of each view image frame with pixel data from the special-effect data.

19. The image processing device of claim 13, wherein the storage unit is further configured to:
store view image frames corresponding to the first view image sequentially in one file; and
store view image frames corresponding to the second view image sequentially in another file.
